(19) United States
(12) Patent Application Publication
(10) Pub. No.: US 2006/0161275 A1
(43) Pub. Date: Jul. 20, 2006

(54) Method for exchanging data between an electric device and a user interface via a data network

(76) Inventors: Manfred Plankl, Traunreut (DE); Christoph Schmitt, Stein an der Traun (DE); Michael Ulmer, Traurent (DE)

Correspondence Address: JOHN T. WINBURN, 100 BOSCH BOULEVARD, NEW BERN, NC, 28562, US

(21) Appl. No.: 10/534,203

(22) PCT Filed: Nov. 13, 2003
(86) PCT No.: PCT/EP03/12711

§ 371 Date: May 6, 2005

(30) Foreign Application Priority Data
Nov. 20, 2002 (DE) 102 54 152.3

(51) Int. Cl. G05B 19/18

(52) U.S. Cl. 700/65

(57) ABSTRACT

A method for exchanging data between an electric device and a user interface via a data network. Control or status information data is exchanged between the electric device and the user interface in the form of data packets. A complete data record containing all control or all status information that is relevant for the control or for the status of the device is transmitted with each packet transmitted.

The invention relates to a method for exchanging data between an electric device and a user interface via a data network.

Known electric devices, especially electrical household appliances, usually have an electronic microprocessor control in which signals from sensors are evaluated and which can trigger certain actions, for example, by actuating actuators, depending on user inputs and the sensor signals received. A central processing and control unit processes both the user inputs and the sensor signals and triggers corresponding pre-determined actions after a plausibility check. For certain applications it can be desirable to have remote control and/or remote monitoring of the electric device which can be accomplished by means of short-range wireless data transmission or by an optical method or by means of radio signals. If communication between user and electric device is to take place over greater distances, the data transmission can suitably be accomplished via a data network, especially a public data network such as the internet.

When data are transmitted in such public data networks such as the internet, the communication data are typically transmitted as smaller data packets which can possibly take different paths in the data network and only be combined again at the recipient. The order of receipt by the recipient can also differ from the transmission order since each data packet contains information relating to a complete correlated data record. These data packets transmitted in quick succession are typically designated as objects, each comprising at least control information or status information. In the case of a cooker, such objects can be, for example, an operating mode, a baking oven temperature, an operating time and a switch-off time. Typically several objects are required for complete control of the appliance. As a result of the control logic stored in the central control unit, a certain sequence for calling up the objects must be adhered to. This also produces a certain reception sequence of the objects in a remote control system. In the case of a cooker, the temperature, the switch-on time and the switch-off time are more appropriately processed by the control after entering the operating mode since, for example, certain temperatures are only possible in certain operating modes. If the correct sequence is not adhered to during the data transmission or is lost, the loss of certain information is associated therewith.

In known remote-controls it is therefore necessary to first transmit the objects before the device is put into operation. Starting the device is only then triggered by a separate command if there is an acknowledgement that all relevant data has arrived at the device. However, this is associated with cumbersome control logic on the one hand since the device cannot be started immediately. In addition, the essential acknowledgement creates additional data traffic and possibly brings about additional costs, for example, if the data transmission is accomplished via a public data network such as the internet.

U.S. Pat. No. 5,883,801 discloses a device and a method for controlling a microwave oven wherein user inputs are coded so that a microprocessor control can thereby be controlled and the inputs can be checked for their plausibility. U.S. Pat. No. 6,198,975 further describes a method for data coding and a data architecture for controlling the parameters of a physical-chemical or a thermodynamic process. Such a process can especially be the operation of a microwave oven.

The object of the present invention is to provide a reliable method for remote control and/or monitoring of an electric device.

According to the invention, this object is solved by a method according to the preamble of claim 1 whereby a complete data record containing all the control information relevant to controlling the electric device is transmitted with each data packet from the user interface. The data record can also contain redundant information which in this case receives a neutral status. For one or a plurality of information items not required, the data packet can in this case contain, for example a “zero” or a specially defined value, e.g. 0xFF or the like. In this way it is clearly defined that the setting of this parameter is not desired but the setting or the status of the relevant parameter should remain unchanged. Using the method according to the invention, certain correlated objects are combined to form so-called collective objects, i.e., in the case of control functions with write access to the electric device, all objects relevant for a state are combined in a common object and transmitted jointly. In this way, the plausibility of the transmitted data is ensured at all times. Also its sequence cannot become disordered since they are transmitted in an individual data block.

In the case of read access to the electric device, i.e., when a status interrogation is made via the internet, the access can take place via a single data object or alternatively via the single objects as desired since the order of the transmission is not critical here. Preferably, however, all the combined objects are used and transmitted here since the amount of data sent over the transmission medium is reduced in this way. In addition, the response time of the complete system can also be reduced with the method according to the invention.

The method according to the invention is especially suitable for remote control and/or for remote monitoring of an electrical household appliance, for example a cooker or the like. Using this method remote control and/or monitoring can be accomplished over large distances via a private or public data network, especially the internet.

In the present context, a user interface can be a control unit which is coupled to the data network, for example, by making a modem connection to the internet. However, the user interface can also be a specific program with a user interface which is simple and clear for a user to operate. This program can, for example, be stored on a certain computer which can be connected to the data network. The program can also be stored on the internet, as desired so that a program can be called up and remote control and/or monitoring can thereby be accomplished using any computer connected to the internet. If necessary, the user interface can also be a program for speech recognition so that a speech-controlled communication with the electric device via the data network can be started by selecting a certain telephone number.

Only control information which cannot trigger any critical situations at the device can preferably be transmitted with the data packets designated as collective objects. For safety reasons the plausibility of the information contained in the data packets is preferably checked. Furthermore, it may be appropriate that safe operation is monitored in the electric device at all times, for example by evaluating signals delivered by temperature sensors, by defining maximum temperatures or other maximum values or by means of a safety shutdown after a certain time has been exceeded.

Further aspects and advantages of the invention are obtained from the dependent claims and from the following description of the figures.

The invention is explained in detail using an exemplary embodiment with reference to the appended drawings. In the figures:

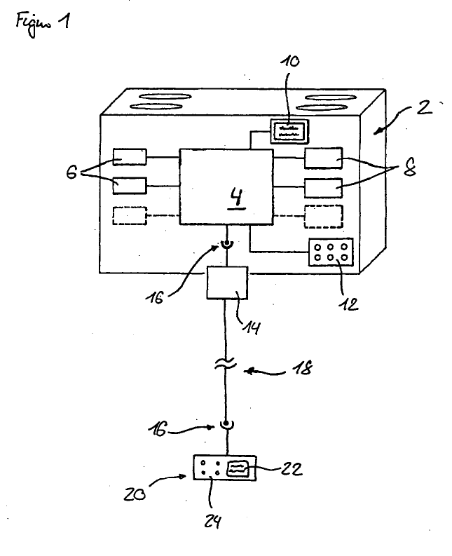

FIG. 1 is a block diagram of an electric device which can be operated using a method according to the invention and

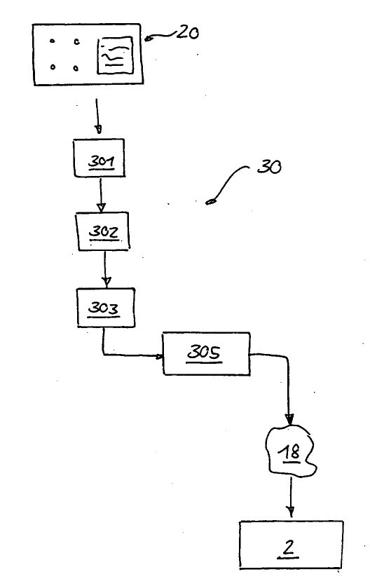

FIG. 2 is a schematic diagram of an exemplary communication sequence in the method according to the invention.

FIG. 1 is a block diagram showing an electric device 2 which can especially be an electrical household appliance such as a cooker or the like. In the exemplary embodiment shown this has a central processing and control unit 4 which can process the output signals of a number of sensors 6. Such a sensor 6 can, for example, be a temperature sensor in a cooker or a flow sensor in a dishwasher or the like. A number of actuators 8 are controlled by the central processing and control unit 4. An actuator 8 is to be understood in this context as any electrically controllable component and/or control element which influences or represents a function in an electric device 2. Such an actuator 8 can, for example, be a cooking surface of an electrical cooker, a water pump or an electrical heater element in a washing machine.

In addition, the central processing and control unit 4 is preferably [connected to] at least one first control panel 12 which serves as a user interface and which transmits inputs made by a user to the central processing and control unit 4. This first control panel 12 can, for example, comprise a plurality of push-button or rotary switches or buttons which can select or influence the various functions or programs on the electric device 2. A first display panel 10 coupled to the central processing and control unit 4 is used to give the user a status indication and possibly warning information at any time during operation. The display panel 10 can, for example, be constructed as a numeric display, as a bar display or the like.

The electric device 2 further comprises a communication interface 14 coupled to the central processing and control unit 4 via a detachable connecting lead 16, via which a connection can be made to a data network 18. The data network 18 can in this case be any computer network, for example, a LAN, a WAN or the internet. FIG. 1 furthermore shows a user interface 20 which also has a detachable connecting lead 16 to the data network 18. The user interface can in principle be constructed as hardware or software which allows user inputs to the electric device 2 and/or user and status queries from the device 2. The user interface 20 can, for example, be constructed as a remote control having a second display panel 22 and a second control panel 24. The second display and control panels 22 and 24 can, however, also be simulated by a program and represented on a screen. An advantageous embodiment of the user interface 20 can, for example, consist of a speech recognition program which allows speech-controlled input an interrogation of an arbitrarily placed communication end device. In this way, the user requires no control equipment, software or hardware to control the electric device 2 or interrogate its status.

An important aspect of the invention is that in principle, only complete data packets are transmitted via the data network 18 which in the present context are designated as collective objects 305 (see FIG. 2) and which contain all parameters or control commands relevant to the control of the electric device 2, hereinafter designated as objects 301, 302, 303. For example, three different inputs are made by the user interface 20, i.e. a first, a second and a third object 301, 302 and 303 are produced. The first object 301 can, for example, be the choice of a cooking surface. The second object 302 can then, for example, characterise the degree of heating or the temperature for this cooking surface. The third object 303 can, for example, characterise a time for which the degree of heating is maintained. The three selected objects are then combined to form the collective object 305 and transmitted as a single data packet to the electric device 2 via the data network 18.

In principle, all the possible control parameters are contained in the collective object 305 so that a data packet always contains complete control information. If one or more of these parameters is “zero”, this information is also transmitted by means of the collective object 305. A substantial simplification of the communication between the user interface 20 and the electric device 2 can thereby be achieved since this does not need to send any acknowledgement as to whether all information has been completely transmitted. Compared with a known type of communication wherein all information is transmitted individually and whose correct receipt must then be confirmed, both the transmission capacity and the transmission time via the data network 18 can be reduced using the method according to the invention. In addition, the method according to the invention ensures that the correct sequence of the transmitted control information is preserved at the central processing and control unit 4 at all times even if the data is transmitted via the internet, for example where correlated data packets possibly take a different transmission path and frequently also have different transmission times.

In the same way, status information can also be transmitted from the device 2 to the user interface 20, namely as collective objects 305 which in each case contain and transmit all relevant status information. Information not required is in the same way characterised by a neutral parameter or by “zero”. In this case, there is no longer any need for confirmation of receipt which would require additional computer and network capacity as well as transmission time.

A safety function of the method according to the invention consists in the fact that the device functions can only be influenced via the communication interface 20 to a limited extent. For example, if an automatic safety shutdown is triggered after a certain time has been exceeded, then this time limit preferably cannot be influenced remotely. A safety shutdown can also be triggered by a temperature being exceeded in a cooker. Here also it is appropriate if the cooker cannot be switched on again remotely but only a maintenance service can be transmitted.

1-8. (canceled)

9. A method for data exchange between an electric device and a user interface via a data network, comprising:
exchanging data between the electric device and the user interface in the form of data packets; and
transmitting a complete data record containing one of all the control information that is relevant for the control of the device and all the relevant status information with each data packet from said user interface to said electric device.

10. The method according to claim 9, including coding control information contained in said data packet and not required for the instantaneous control of said device with neutral parameter information.

11. The method according to claim 9, including coding status information contained in said data packet and not required by said user interface with neutral parameter information.

12. The method according to claim 9, including providing an electrical household appliance and controlling and monitoring said electrical household appliance with said data packets transmitted from said user interface.

13. The method according to claim 9, including said data network is a public data network, especially the internet.

14. The method according to claim 9, including said user interface forming at least a component of a control unit.

15. The method according to claim 14, including said user interface forming said control unit.

16. An electric device, comprising:
a control unit:
a remote user interface coupled to said control unit via a data network;
said remote user interface communicating with said control unit via said data network;
exchanging data between said control unit and said user interface by transmitting said data via said data network in the form of data packets;
each said data packet forming a complete data record; and
each said data record containing one of all the control information that is relevant for the control of said device and all the relevant status information with each data packet transmitted from said user interface to said control unit.

17. The electric device according to claim 16, including control information contained in said data packet and not required for the instantaneous control of said device coded with neutral parameter information.

18. The electric device according to claim 16, including status information contained in said data packet and not required by said user interface coded with neutral parameter information.

19. The electric device according to claim 16, wherein the electric device is an electrical household appliance and said control unit controls and monitors said electrical household appliance using said data packets transmitted from said user interface.

20. The electric device according to claim 16, including said data network is a public data network, especially the internet.

21. The electric device according to claim 16, including said user interface forms at least a component of a second control unit.

22. The electric device according to claim 21, including said user interface formss said second control unit.
